(19) United States
(12) Patent Application Publication
(10) Pub. No.: US 2020/0379954 A1
(43) Pub. Date: Dec. 3, 2020

(54) FILE PROCESSING METHOD FOR VEHICLE MOUNTED MONITORING DEVICE AND VEHICLE MOUNTED MONITORING DEVICE

(71) Applicant: BOE Technology Group Co., Ltd., Beijing (CN)

(72) Inventors: Yan Shen, Beijing (CN); Hongli Wang, Beijing (CN); Jing Yu, Beijing (CN); Xingxing Zhao, Beijing (CN)

(21) Appl. No.: 16/469,802

(22) PCT Filed: Aug. 24, 2018
(86) PCT No.: PCT/CN2018/102256

§ 371 Date: Jun. 14, 2019

(30) Foreign Application Priority Data
Jan. 19, 2018 (CN) 201810055037.2

(51) Int. Cl. G06F 16/176; G06K 9/00; G06F 16/13; G06F 16/17; G07C 5/08

(52) U.S. Cl. CPC G06F 16/1774; G06K 9/00791; G06K 9/00845; H04N 7/183; G06F 16/1727; G07C 5/085; G06F 16/13

(57) ABSTRACT

The present disclosure relates to a file processing method for a vehicle-mounted monitoring device and a vehicle-mounted monitoring device. The file processing method includes: acquiring locking weights of files in a local storage space if it is detected that a size of an occupied space in the local storage space is greater than or equal to a first storage threshold; and processing the files according to the locking weights.

### CROSS-REFERENCE TO RELATED APPLICATION(S)

This application is a Section 371 National Stage of International Application No. PCT/CN2018/102256, filed on 24 Aug. 2018, which has not yet published, and claims priority to Chinese Patent Application No. CN201810055037.2, filed on Jan. 19, 2018, both of which are incorporated herein by reference.

### TECHNICAL FIELD

The present disclosure relates to the field of data storage technologies, and more particularly, to a file processing method for a vehicle-mounted monitoring device and a vehicle-mounted monitoring device.

### BACKGROUND

Currently, video devices are applied more and more widely. When a video device is used as a vehicle-mounted monitoring device, it may record monitoring data such as videos and pictures and store the monitoring data in a local storage space. Due to a limited local storage space, the oldest monitoring data may be deleted in an order of recording time in the related technologies. This solution of deleting monitoring data in an order of recording time may delete some important monitoring data, which may result in failure in collection of evidence when the vehicle is in an accident.

### SUMMARY

According to a first aspect of the embodiments of the present disclosure, there is provided a file processing method for a vehicle-mounted monitoring device, comprising:

acquiring locking weights of files in a local storage space if it is detected that a size of an occupied space in the local storage space is greater than or equal to a first storage threshold; and

processing the files according to the locking weights.

In an embodiment, before acquiring locking weights of files in a local storage space, the method further comprising:

determining a scene where the vehicle-mounted monitoring device is located; and

determining, based on the scene, the locking weights according to a scene locking policy.

In an embodiment, determining a scene where the vehicle-mounted monitoring device is located comprises:

receiving a vehicle environmental parameter collected by each of sensing devices on the vehicle; and

determining, based on a matching relationship between vehicle environmental parameters and scenes, the scene where the vehicle-mounted monitoring device is located according to the collected vehicle environmental parameter.

In an embodiment, the sensing devices each comprise at least one of an acceleration sensing device, a blind spot monitoring device, a fatigue detection device, a pedestrian detection device, a speed sensor, an image collection device, and an interactive device.

In an embodiment, the method further comprises:

acquiring recording times of the files in the local storage space,

wherein processing the files according to the locking weights comprises:

processing the files according to the locking weights and the recording times.

In an embodiment, processing the files according to the locking weights and the recording times comprises:

determining, based on a matching relationship between locking weights and locking score values, locking score values of the files according to the locking weights;

determining, based on a matching relationship between recording times and time score values, time score values of the files according to the recording times;

determining importance score values of the files according to the locking score values and the time score values; and

deleting files each having an importance score value less than or equal to an importance threshold and storing files each having an importance score value greater than the importance threshold.

In an embodiment, after storing files each having an importance score value greater than the importance threshold, the method further comprises:

deleting the stored files in an ascending order of importance score values if the size of the occupied space in the local storage space is greater than or equal to a second storage threshold, until the size of the occupied space is less than or equal to the second storage threshold,

wherein the second storage threshold is less than the first storage threshold.

In an embodiment, after processing the files according to the locking weights and the recording times, the method further comprises:

acquiring an increase rate of the occupied space of the files in the local storage space; and

adjusting the second storage threshold according to the increase rate,

wherein the increase rate is negatively proportional to the second storage threshold.

In an embodiment, after processing the files according to the locking weights, the method further comprises:

determining whether the vehicle-mounted monitoring device communicates with a cloud; and

uploading the stored files to the cloud in a descending order of importance score values in response to determining that the vehicle-mounted monitoring device communicates with the cloud.

According to a second aspect of the embodiments of the present disclosure, there is provided a vehicle-mounted monitoring device, comprising:

one or more processors; and

one or more memories connected to the one or more processors and having instructions stored thereon, wherein the instructions which, when executed on the one or more processors, cause the one or more processors to be configured to:

acquire locking weights of files in a local storage space if it is detected that a size of an occupied space in the local storage space is greater than or equal to a first storage threshold; and

process the files according to the locking weights.

In an embodiment, the one or more processors are further configured to:

determine a scene where the vehicle-mounted monitoring device is located; and

determine, based on the scene, the locking weights according to a scene locking policy.

In an embodiment, the one or more processors are further configured to:

receive a vehicle environmental parameter collected by each of sensing devices on the vehicle; and

determine, based on a matching relationship between vehicle environmental parameters and scenes, the scene where the vehicle-mounted monitoring device is located according to the collected vehicle environmental parameter.

In an embodiment, the sensing devices each comprise at least one of an acceleration sensing device, a blind spot monitoring device, a fatigue detection device, a pedestrian detection device, a speed sensor, an image collection device, and an interactive device.

In an embodiment, the one or more processors are further configured to:

acquire recording times of the files in the local storage space, and

process the files according to the locking weights and the recording times.

In an embodiment, the one or more processors are further configured to:

determine, based on a matching relationship between locking weights and locking score values, locking score values of the files according to the locking weights;

determine, based on a matching relationship between recording times and time score values, time score values of the files according to the recording times; and

determine importance score values of the files according to the locking score values and the time score values; and

delete files each having an importance score value less than or equal to an importance threshold and store files each having an importance score value greater than the importance threshold.

In an embodiment, the one or more processors are further configured to:

delete the stored files in an ascending order of importance score values if the size of the occupied space in the local storage space is greater than or equal to a second storage threshold, until the size of the occupied space is less than or equal to the second storage threshold,

wherein the second storage threshold is less than the first storage threshold.

In an embodiment, the one or more processors are further configured to:

acquire an increase rate of the occupied space of the files in the local storage space; and

adjust the second storage threshold according to the increase rate,

wherein the increase rate is negatively proportional to the second storage threshold.

In an embodiment, the one or more processors are further configured to:

determine whether the vehicle-mounted monitoring device communicates with a cloud; and

upload the stored files to the cloud in a descending order of importance score values in response to determining that the vehicle-mounted monitoring device communicates with the cloud.

It should be understood that the above general description and the following detailed description are intended to be exemplary and illustrative and should not be construed as limiting the present disclosure.

### BRIEF DESCRIPTION OF THE ACCOMPANYING DRAWINGS

The accompanying drawings, which are incorporated in the specification and constitute a part of the specification, illustrate the embodiments according to the present disclosure, and are used to explain the principles of the present disclosure together with the specification.

FIG. 1 is a flowchart of a file processing method for a vehicle-mounted monitoring device according to an embodiment of the present disclosure;

FIG. 2 is a flowchart of a file processing method for a vehicle-mounted monitoring device according to another embodiment of the present disclosure;

FIG. 3 is a flowchart of a file processing method for a vehicle-mounted monitoring device according to still another embodiment of the present disclosure;

FIG. 4 is a flowchart of processing files based on locking weights and recording times according to an embodiment of the present disclosure;

FIG. 5 is a flowchart of a file processing method for a vehicle-mounted monitoring device according to still another embodiment of the present disclosure;

FIG. 6 is a flowchart of a file processing method for a vehicle-mounted monitoring device according to still another embodiment of the present disclosure;

FIGS. 7 to 13 are block diagrams of a file processing apparatus for a vehicle-mounted monitoring device according to an embodiment of the present disclosure; and

FIG. 14 is a schematic structural diagram of a vehicle-mounted monitoring device according to an embodiment of the present disclosure.

### DETAILED DESCRIPTION

Exemplary embodiments will be described in detail herein, and examples of the embodiments are illustrated in the accompanying drawings. When the following description refers to the accompanying drawings, the same numbers in different figures represent the same or similar elements, unless otherwise indicated. Implementations described in the following exemplary embodiments do not represent all implementations according to the present disclosure. Instead, they are merely examples of apparatuses and methods according to some aspects of the present disclosure as detailed in the appended claims.

It may be understood that the file processing method according to the embodiment of the present disclosure may be applied to an electronic device such as a monitoring device, a camera, a video collection device, an audio collection device, etc. These electronic devices may continuously collect audio and video data (collectively referred to as files later) for a period of time and store the data in a local storage space. The local storage space may be a solid state hard disk, a mechanical hard disk, and other readable storage media. Due to the limited local storage space, after the electronic device operates for a period of time, the local storage space may be used up, thereby affecting an operation of a system and software and data storage of the electronic device. If data is deleted in an order of storage time, critical data may be deleted, thereby resulting in failure in acquisition of the critical data in some scenes. In this case, the file processing method according to the present embodiment may be applied to the above electronic device, to firstly detect whether a size of an occupied space in the local storage space is greater than or equal to a storage threshold, and acquire a locking weight of each of files in the local storage space when the size of the occupied space is greater than or equal to the storage threshold. Then, corresponding files are processed according to the locking weights.

Thus, in the present embodiment, the monitoring data may be processed according to the locking weights, so that monitoring data having a large weight may be retained, that is, monitoring data which is relatively important may not be deleted, which is beneficial to subsequent query and evidence collection, and improves the user experience.

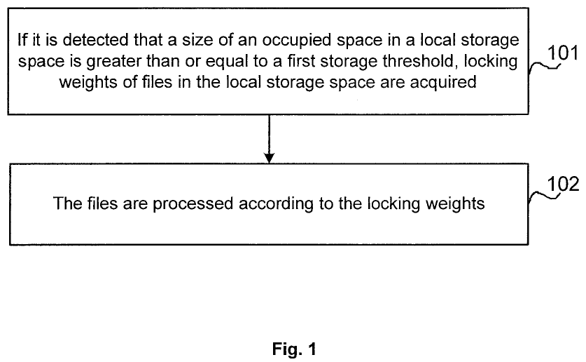

In order to simplify the description, the above file processing method is applied to a vehicle-mounted monitoring device in the embodiments of the present disclosure. FIG. 1 is a flowchart of a file processing method for a vehicle-mounted monitoring device according to an embodiment of the present disclosure. As shown in FIG. 1, the file processing method for the vehicle-mounted monitoring device comprises the following steps.

In step 101, if it is detected that a size of an occupied space in a local storage space is greater than or equal to a first storage threshold, locking weights of files in the local storage space are acquired.

In the present embodiment, the first storage threshold is pre-stored in the vehicle-mounted monitoring device. For example, if a size of the local storage space is 100 GB, the first storage threshold may be 90 GB, 80 GB, etc. In addition, the first storage threshold may also be a percentage of the local storage space, for example, 90%, 80%, etc. Those skilled in the art may set a form of the first storage threshold according to a specific scene. It may be understood that when the first storage threshold is a percentage, the first storage threshold needs to be converted, which will not be described here.

Firstly, the size of the occupied space in the local storage space at current time may be acquired by a processor actively querying the size of the occupied space from the local storage space, or the local storage space transmitting the size of the occupied space to the processor in real time or periodically, which both may realize the solution according to the present embodiment, and will not be limited herein.

The size of the occupied space is then directly compared with the first storage threshold. Of course, it is also possible to calculate a ratio of the size of the occupied space to a maximum value of the local storage space, and then compare the ratio with the first storage threshold.

Further, when the size of the occupied space is less than the first storage threshold, the above acquiring and comparing processes continue to be performed. When the size of the occupied space is greater than or equal to the first storage threshold, a locking weight of each of files in the local storage space is acquired.

It should be illustrated that the locking weights are values corresponding to weight identities of the corresponding files, for example, 1-N, and the locking weights are used to indicate importance of the corresponding files. For example, a first level of a locking weight is represented by a value of “1”, a second level of a locking weight is represented by a value of “2”, a third level of a locking weight is represented by a value of “3”, and so on. It may be understood that if a locking weight has a value of “1”, it indicates that a corresponding file is very important; if a locking weight has a value of “2”, it indicates that a corresponding file is important; if a locking weight has a value of “3”, it indicates that a corresponding file is generally important; if a locking weight has a value of “4”, it indicates that a corresponding file is not important; and if locking weight has a value of “5”, it indicates that a corresponding file is a junk file. The levels and values of the locking weights may be set according to specific scenes. Of course, the locking weights may also be positively correlated with the values, that is, the larger the value, the larger the locking weight, and the higher the level, which may be set by those skilled in the art according to specific scenes.

The levels and values of the above locking weights may be set by a driver or may be determined according to a scene where the vehicle-mounted monitoring device is located, which will not be described here, and will be described in detail in subsequent embodiments.

In the subsequent embodiments, description is made by an example in which the smaller the value of the locking weight, the higher the level of the file, and the more important the file.

In step 102, the files are processed according to the locking weights.

In the present embodiment, the files are ranked in a descending or ascending order of the values or levels of the locking weights. In an embodiment, the files are ranked in an order of the values of the locking weights. Then, files each having a large locking weight (a low level) are deleted sequentially until the size of the occupied space in the local storage space is less than the first storage threshold.

In the present embodiment, when it is detected that the size of the occupied space in the local storage space is greater than or equal to the first storage threshold, a locking weight of each monitoring data in the local storage space is acquired, and the monitoring data is processed according to the locking weights. Thus, in the present embodiment, the monitoring data may be processed according to the locking weights, so that monitoring data having a large weight may be retained, that is, monitoring data which is relatively important may not be deleted, which is beneficial to subsequent query and evidence collection, and improves the user experience.

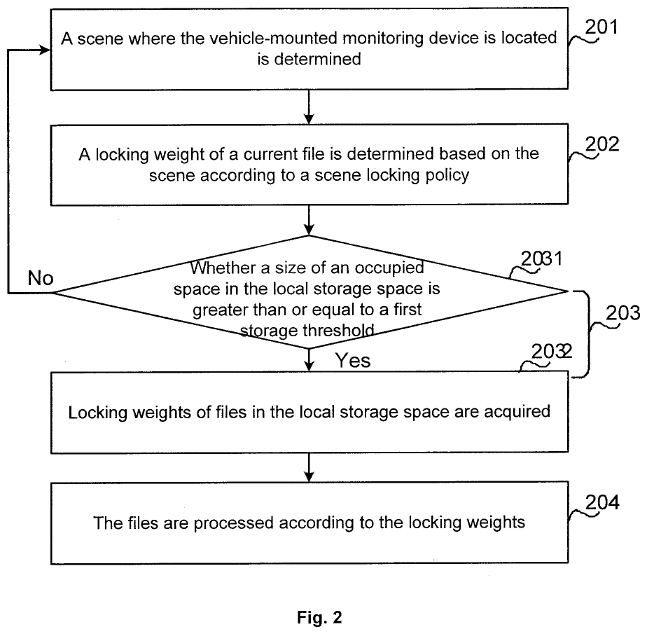

In order to solve the problem that locking weights which are set manually may be inaccurate, in the present embodiment, the locking weights are determined based on a scene where the vehicle-mounted monitoring device is located. FIG. 2 is a flowchart of a file processing method for a vehicle-mounted monitoring device according to an embodiment of the present disclosure. As shown in FIG. 2, the file processing method for the vehicle-mounted monitoring device comprises the following steps.

In step 201, a scene where the vehicle-mounted monitoring device is located is determined.

In practical applications, there are sensing devices disposed at set positions on the vehicle. For example, the sensing devices comprise at least one of an acceleration sensing device, a blind spot monitoring device, a fatigue detection device, a pedestrian detection device, a speed sensor, an image collection device, and an interactive device.

In the present embodiment, the vehicle-mounted monitoring device receives a vehicle environmental parameter collected by each of the sensing devices on the vehicle. For example, the acceleration sensing device may detect an acceleration of the vehicle in real time or periodically; the blind spot monitoring device may acquire audio and video data in a blind spot area of the vehicle in real time or periodically; the fatigue detection device may detect a physiological parameter of a driver in real time or periodically to determine whether the driver is in a fatigue state; the pedestrian detection device may detect the presence or absence of a pedestrian around the vehicle in real time or periodically; the speed sensor may detect a speed of the vehicle in real time or periodically; the image collection device may detect traffic lights in front of the vehicle in real time or periodically; and the interactive device may acquire a trigger action of a user to trigger locking of a file.

All the above sensing devices may be combined or adjusted according to specific scenes, so that different vehicle environmental parameters may be received.

In the present embodiment, the scene where the vehicle-mounted monitoring device is located may be determined based on the vehicle environmental parameter according to a matching relationship between vehicle environmental parameters and scenes.

In step 202, a locking weight of a current file is determined based on the scene according to a scene locking policy.

In the present embodiment, after the scene is acquired, a locking weight of a current file may be determined according to a scene locking policy, which may comprise:

determining that the locking weight belongs to a first level if a blind spot monitoring device generates an alarm in the scene;

determining that the locking weight belongs to the first level if an acceleration sensing device detects that an acceleration of the vehicle exceeds an acceleration threshold in the scene;

determining that the locking weight belongs to the first level if a fatigue detection device detects that a driver is driving in a fatigue state in the scene;

determining that the locking weight belongs to the first level if an interactive device detects that the driver actively locks in the scene;

determining that the locking weight belongs to a second level if a pedestrian detection device detects that there is a pedestrian within a set range of the vehicle in the scene;

determining that the locking weight belongs to the second level if a speed sensor detects that the vehicle is running over speed in the scene;

determining that the locking weight belongs to the second level if an image collection device detects that the vehicle is running in a set environment in the scene;

determining that the locking weight belongs to a third level if an image collection device detects traffic lights in the scene;

determining that the locking weight belongs to the third level if an image collection device detects the vehicle is running on a line in the scene; and

determining that the locking weight belongs to a fourth level in a scene other than the above scenes.

In the present embodiment, only a part of the scenes and the locking weights are described. Those skilled in the art may combine multiple sensors in the sensing devices to acquire a scene corresponding to multiple constraints. On the basis of the corresponding scene, the levels of the locking weights are sub-divided. It may be understood that the solution according to the present embodiment may also be implemented regardless of the combination or adjustment.

In the present embodiment, the vehicle-mounted monitoring device collects files such as audio and video etc. based on the determined locking weights, and stores the files in a local storage space.

It should be illustrated that the vehicle usually moves at a speed between 10 Km/h and 80 Km/h, that is, the vehicle moves about 0 to 20 meters per second, and each scene corresponds to a certain time period or position. For example, if traffic lights are only within tens of meters from the vehicle, the scene may pass after the vehicle passes through the traffic lights. As another example, if there is a pedestrian in front of the vehicle, there is a dangerous scene in a range from the pedestrian to tens of meters from the vehicle. In this case, if the vehicle passes firstly, it may take several seconds, and if the pedestrian passes firstly, It may take more than ten seconds. Therefore, in order to ensure the real-time performance of the scene, in an embodiment, the vehicle-mounted monitoring device stores a file using a locking weight within a preset time period after determining the locking weight value. The above preset time period may be adjusted according to different scenes.

For example, when it is determined that a driver is driving in a fatigue state in the scene, it is determined that the locking weight belongs to the first level, and the preset time period may be set to 5 minutes. Then, a file is stored using the locking weight corresponding to the first level in a timing process, and after the timing process is completed, storage of a next scene is performed. The next scene may be acquired in the timing process or after the timing process is completed, which is not limited in the present embodiment.

As another example, when it is determined that a vehicle is running on a line in the scene, it is determined that the locking weight belongs to the third level, and the preset time period may be set to 30 seconds. Then, a file is stored using the locking weight corresponding to the third level in a timing process. Storage of a next scene is performed after the timing process is completed.

In addition, if scenes are continuously acquired in a timing process, and a locking weight of a next scene is higher than that of a current scene, when the current scene is switched to the next scene, a file is stored using a new locking weight.

In step 2031, it is detected whether a size of an occupied space in the local storage space is greater than or equal to a first storage threshold. If the size of the occupied space is less than the first storage threshold, step 201 and step 202 continue to be performed, and if the size of the occupied space is greater than or equal to the first storage threshold, step 2032 is performed.

In step 2032, a locking weight of each of files in the local storage space is acquired.

Here, steps 2031 and 2032 constitute step 203, which has the same specific method and principle as those of step 101. Detailed description of step 203 may be known with reference to related content of FIG. 1 and step 101, and will not be described herein again.

In step 204, the files are processed according to the locking weights.

Here, step 204 has the same specific method and principle as those of step 102. Detailed description of step 204 may be known with reference to related content of FIG. 1 and step 102, and will not be described herein again.

In the present embodiment, the scene where the vehicle is located (i.e., the scene where the vehicle-mounted monitoring device is located) may be determined according to the sensing devices on the vehicle, and then the locking weights of the files collected by the vehicle-mounted monitoring device are determined according to the scene. Thereby, it may be ensured that the locking weights of the files corresponds to the scene, so that critical files are accurately acquired, which is beneficial to efficiency and accuracy of subsequent deletion, and improves the usage efficiency.

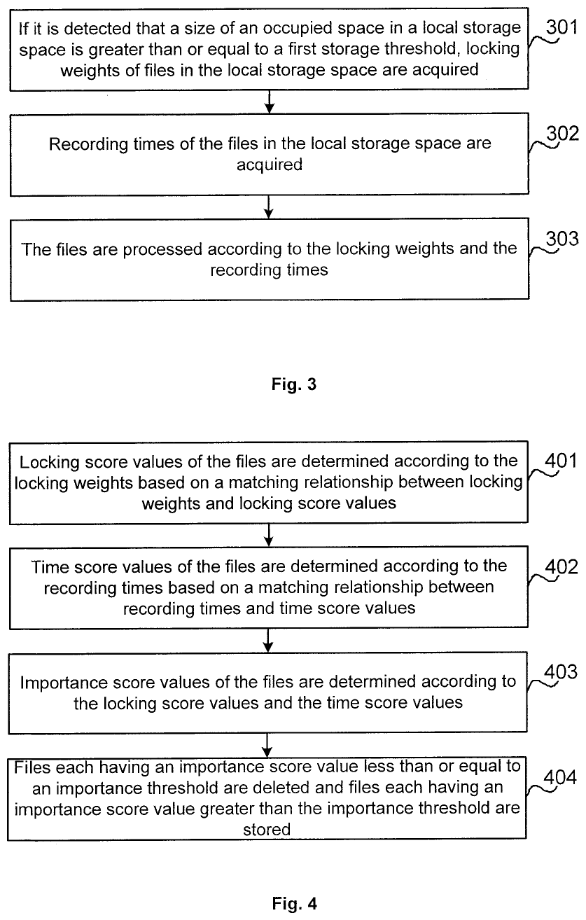

FIG. 3 is a flowchart of a file processing method for a vehicle-mounted monitoring device according to still another embodiment of the present disclosure. As shown in FIG. 3, the file processing method for the vehicle-mounted monitoring device comprises the following steps.

In step 301, if it is detected that a size of an occupied space in a local storage space is greater than or equal to a first storage threshold, a locking weight of each of files in the local storage space is acquired.

Here, step 301 has the same specific method and principle as those of step 101. Detailed description of step 301 may be known with reference to the related content of FIG. 1 and step 101, and will not be described herein again.

In step 302, recording times of the files in the local storage space is acquired.

When the files are ranked in consideration of the locking weights, there will be a case that files have the same rank (i.e., having the same locking weight) but have different recording times. Therefore, in the present embodiment, when it is detected that the size of the occupied space in the local storage space is greater than or equal to the first storage threshold, the recording times of the files is further acquired.

It may be understood that since there may be a case that a file is stored manually in the local storage space, the above recording times may also be adjusted to storage time. That is, the above recording times may be adjusted to a time value under any time reference system, which will not be described in detail herein.

It should be illustrated that an order of step 302 and step 301 of acquiring the locking weight of each of the files is not limited, and the locking weights may be acquired before the recording times are acquired, or the recording times may be acquired before the locking weights are acquired, or the recording times and the locking weights may be acquired at the same time.

In step 303, the files are processed according to the locking weights and the recording times.

In the present embodiment, processing the files based on the locking weights and the recording times comprises the following manners.

In a first manner, firstly, the files are ranked according to values of the locking weights. In the ranking process, files having the same locking weight are ranked in a chronological order. Then, the files are controlled to be deleted in a descending order of the locking weights. When multiple files correspond to the same locking weight, the files are deleted starting from a file having the earliest recording time, until the size of the local storage space is less than the first storage threshold.

In a second manner, as shown in FIG. 4, in step 401, locking score values of the files are determined according to the locking weights based on a matching relationship between locking weights and locking score values.

Here, the matching relationship between the locking weights and the locking score values may be preset in the vehicle-mounted monitoring device. For example, if a locking weight has a value of “1”, a corresponding locking score value is 50; if a locking weight has a value of “2”, a corresponding locking score value is 40; if a locking weight has a value of “3”, a corresponding locking score value is 30; if a locking weight has a value of “4”, a corresponding locking score value is 20; if a locking weight has a value of “5”, a corresponding locking score value is 10, and so on.

After determining the locking weights, the locking score values of the files may be acquired according to the above matching relationship.

In step 402, time score values of the files are determined according to the recording times based on a matching relationship between recording times and time score values.

Here, the matching relationship between the recording times and the time score values may be preset in the vehicle-mounted monitoring device. For example, a period between the earliest recording time and the most recent recording time corresponding to the stored files is divided into a plurality of time periods, wherein each of the time periods corresponds to one time score value. It may be understood that the earlier the recording time, the smaller the corresponding time score value. For example, if recording time is “10 days ago”, a corresponding time score value is 0; if recording time is “8 days ago”, a corresponding time score value is 10; if recording time is “6 days ago”, a corresponding time score value is 20; if recording time is “4 days ago”, a corresponding time score value is 30; if recording time is “2 days ago”, a corresponding time score value is 40; if recording time is “1 day ago”, a corresponding time score value is 50; if recording time is within 0-24 hours, a corresponding time score value is 60; and so on. Then, after recording time of a file is acquired, it may be determined which time period the recording time is located, so as to obtain a corresponding time score value.

It should be illustrated that the above time score values and the above locking score values need to be correspondingly adjusted to the same order of magnitude, so that both the time score values and the locking score values have the same importance.

In step 403, importance score values of the files are determined according to the locking score values and the time score values.

In the present embodiment, the importance score values of the files may be calculated directly according to the locking score values and the time score values. Of course, weighting coefficients may further be set for the locking score values and the time score values according to a specific scene, to acquire importance score values at different importance.

In step 404, files each having an importance score value less than or equal to an importance threshold are deleted and files each having an importance score value greater than the importance threshold are stored.

Thus, in the present embodiment, by combining the locking weights and the recording times, files each having a large locking weight and early recording time may be deleted, and thereby files each having a small locking weight and recent recording time may be retained. In this way, it may be ensured that not only there is enough remaining space in the local storage space, but also the stored files are relatively important files, which is beneficial to subsequent road condition query and evidence collection, and improves the user experience.

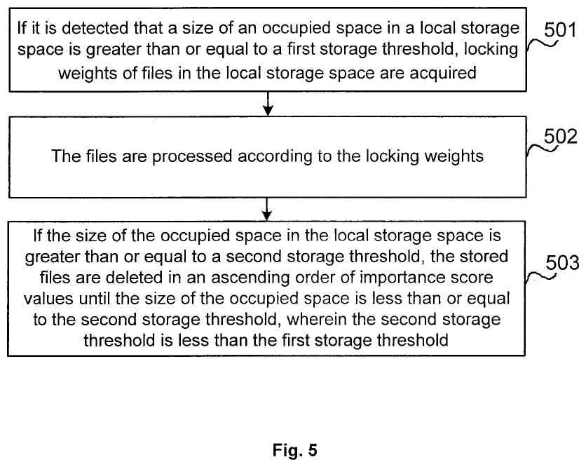

FIG. 5 is a flowchart of a file processing method for a vehicle-mounted monitoring device according to still another embodiment of the present disclosure. As shown in FIG. 5, the file processing method for the vehicle-mounted monitoring device comprises the following steps.

In step 501, if it is detected that a size of an occupied space in a local storage space is greater than or equal to a first storage threshold, a locking weight of each of files in the local storage space is acquired.

Here, step 501 has the same specific method and principle as those of step 101. Detailed description of step 501 may be known with reference to the related content of FIG. 1 and step 101, and will not be described herein again.

In step 502, the files are processed according to the locking weights.

Here, step 502 has the same specific method and principle as those of step 102. Detailed description of step 502 may be known with reference to the related content of FIG. 1 and step 102, and will not be described herein again.

In step 503, if the size of the occupied space in the local storage space is greater than or equal to a second storage threshold, the stored files are deleted in an ascending order of importance score values until the size of the occupied space is less than or equal to the second storage threshold, wherein the second storage threshold is less than the first storage threshold.

In practical applications, each file deletion process may occupy system resources of the vehicle-mounted monitoring device, and thereby the vehicle-mounted monitoring device may run slowly or even crash. Therefore, it is necessary to reduce a frequency at which files are deleted or stop deleting the files when the vehicle stops. In this case, it is necessary to delete files as many as possible each time, which may improve the performance of the vehicle-mounted monitoring device.

A manner in which the files are deleted in the present embodiment may be known with reference to the content of step 102 and FIG. 2, and will not be described in detail herein. That is, in each file deletion process, the files are deleted until the size of the occupied space in the local storage space is less than the second storage threshold.

A manner in which the above second storage threshold is set may be known with reference to the manner in which the first storage threshold is set, and the second storage threshold is less than the first storage threshold. For example, if the size of the local storage space is 100 GB, the first storage threshold may be 90 GB, and the second storage threshold may be 80 GB or less.

Considering that various vehicles may run at different frequencies, an increase rate of the occupied space of the files in the local storage space may change, and thereby a frequency at which the files are deleted by the vehicle-mounted monitoring device may change. Therefore, in the present embodiment, the second storage threshold is further adjusted according to the increase rate of the storage space, which comprises:

acquiring the increase rate of the occupied space of the files in the local storage space; and

adjusting the second storage threshold according to the increase rate, wherein the increase rate is negatively proportional to the second storage threshold.

For example, the occupied space in the local storage space is 85 GB at first time, and the occupied space of the local storage space is 86 GB at second time. In this case, an increase rate of the occupied space from the first time to the second time is 1 GB/unit time. If the increase rate is greater than a set threshold, the second storage threshold may be adjusted from 80 GB to 75 GB. As another example, when the increase rate of the occupied space is 2 GB/unit time, since the increase rate is greater than the set threshold, the second storage threshold may be adjusted from 80 GB to 70 GB, and so on. If the increase rate is less than the set threshold, the second storage threshold is not adjusted.

Of course, the solution corresponding to steps 501 and 502 may be replaced by the solution corresponding to steps 301 to 303, and will not be described in detail herein.

In the present embodiment, the second storage threshold is set and adjusted in consideration of the frequency at which each vehicle runs and the increase rate, so as to adjust the frequency at which the files are deleted, which ensures that there is enough space in the local storage space to store the files, while ensuring the operation efficiency of the system and software in the vehicle-mounted monitoring device.

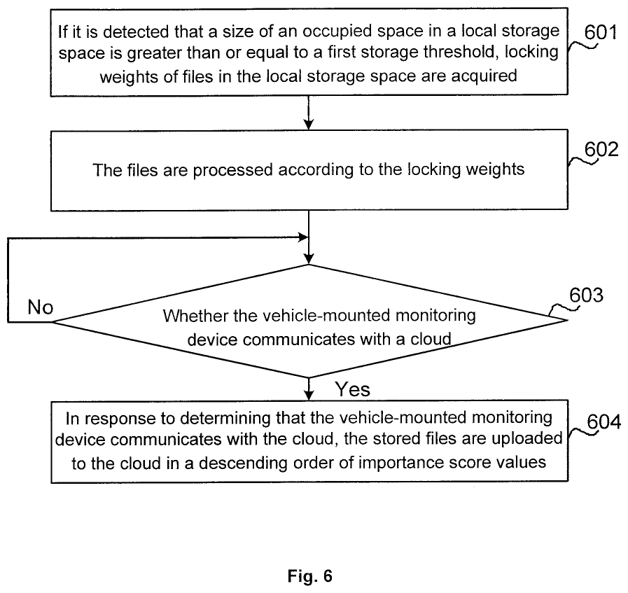

FIG. 6 is a flowchart of a file processing method for a vehicle-mounted monitoring device according to still another embodiment of the present disclosure. As shown in FIG. 6, the file processing method for the vehicle-mounted monitoring device comprises the following steps.

In step 601, if it is detected that a size of an occupied space in a local storage space is greater than or equal to a first storage threshold, a locking weight of each of files in the local storage space is acquired.

Here, step 601 has the same specific method and principle as those of step 101. Detailed description of step 601 may be known with reference to the related content of FIG. 1 and step 101, and will not be described herein again.

In step 602, the files are processed according to the locking weights.

Here, step 602 has the same specific method and principle as those of step 102. Detailed description of step 602 may be known with reference to the related content of FIG. 1 and step 102, and will not be described herein again.

In step 603, it is determined whether the vehicle-mounted monitoring device communicates with a cloud.

In the present embodiment, the vehicle-mounted monitoring device may transmit a connection establishment request to the cloud in real time or periodically. If the vehicle-mounted monitoring device does not receive response information matching the connection establishment request within specified time, the vehicle-mounted monitoring device determines that it fails to communicate with the cloud. Then, the vehicle-mounted monitoring device continues to transmit the connection establishment request.

If the vehicle-mounted monitoring device receives the response information matching the connection establishment request within the specified time, the vehicle-mounted monitoring device determines that it may communicate with the cloud.

In step 604, in response to determining that the vehicle-mounted monitoring device communicates with the cloud, the stored files are uploaded to the cloud in a descending order of importance score values.

Then, the stored files are uploaded to the cloud in a descending order of importance score values. Of course, the stored files may also be uploaded to the cloud according to levels of the locking weights.

All the files in the local storage space are uploaded to the cloud, or only files which are updated most recently are uploaded to the cloud. After each of the files is successfully uploaded, the file may be deleted at the same time, thereby reducing the usage efficiency of the local storage space.

In the present embodiment, when the vehicle-mounted monitoring device determines that it may communicate with the cloud, the vehicle-mounted monitoring device uploads the stored files to the cloud, so that critical files may be stored, which is beneficial to subsequent road condition query and evidence collection, and improves the user experience.

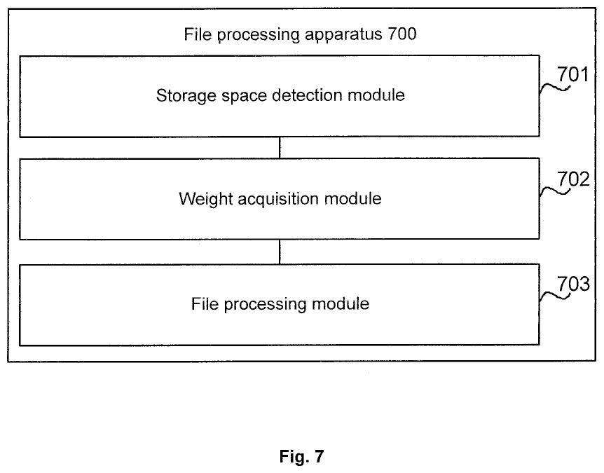

FIG. 7 is a block diagram of a file processing apparatus for a vehicle-mounted monitoring device according to an embodiment of the present disclosure. As shown in FIG. 7, the file processing apparatus 700 for the vehicle-mounted monitoring device comprises:

a storage space detection module 701 configured to detect whether a size of an occupied space in a local storage space is greater than or equal to a first storage threshold, and transmit a trigger signal to a weight acquisition module when the detection result indicates that the size of the occupied space is greater than or equal to the first storage threshold;

the weight acquisition module 702 configured to acquire a locking weight of each of files in the local storage space when receiving the trigger signal from the storage space detection module; and

a file processing module 703 configured to process the files according to the locking weights.

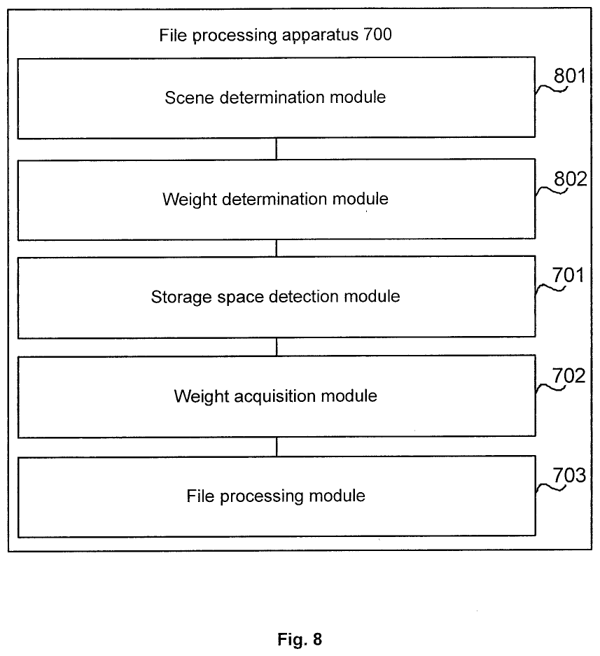

As shown in FIG. 8, on the basis of the file processing apparatus shown in FIG. 7, the apparatus 700 further comprises:

a scene determination module 801 configured to determine a scene where the vehicle-mounted monitoring device is located;

a weight determination module 802 configured to determine, based on the scene, a locking weight of a current file according to a scene locking policy.

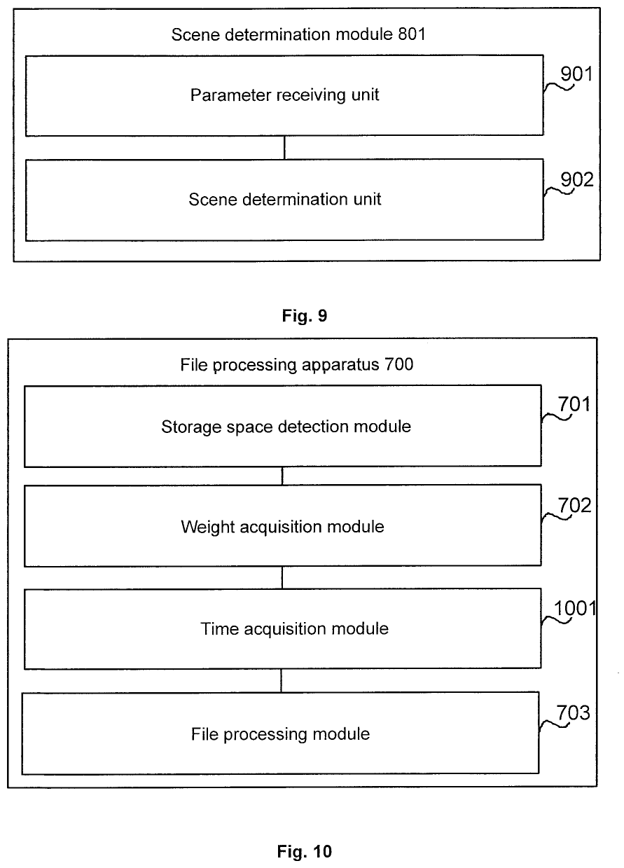

As shown in FIG. 9, on the basis of the file processing apparatus shown in FIG. 8, the scene determination module 801 comprises:

a parameter receiving unit 901 configured to receive a vehicle environmental parameter collected by each of sensing devices on the vehicle;

a scene determination unit 902 configured to determine, based on a matching relationship between vehicle environmental parameters and scenes, a scene where the vehicle-mounted monitoring device is located according to the collected vehicle environmental parameter.

Alternatively, the sensing devices comprise at least one of an acceleration sensing device, a blind spot monitoring device, a fatigue detection device, a pedestrian detection device, a speed sensor, an image collection device, and an interactive device.

FIG. 10 is a block diagram of a file processing apparatus for a vehicle-mounted monitoring device according to an embodiment of the present disclosure. As shown in FIG. 10, on the basis of the file processing apparatus shown in FIG. 7, the apparatus 700 comprises:

a time acquisition module 1001 configured to acquire recording times of files in the local storage space, wherein

the file processing module 703 is further configured to process the files according to the locking weights and the recording times.

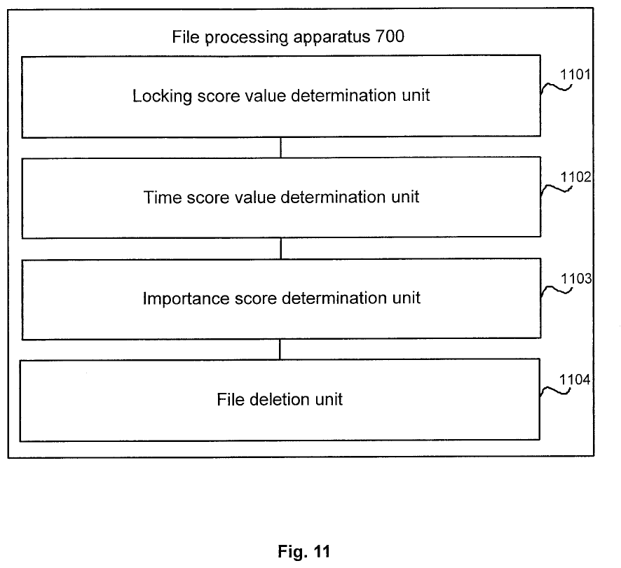

As shown in FIG. 11, on the basis of the file processing apparatus shown in FIG. 10, the file processing module 703 comprises:

a locking score value determination unit 1101 configured to determine, based on a matching relationship between locking weights and locking score values, locking score values of the files according to the locking weights;

a time score value determination unit 1102 configured to determine, based on a matching relationship between recording times and time score values, time score values of the files according to the recording times; and

an importance score determination unit 1103 configured to determine importance score values of the files according to the locking score values and the time score values; and

a file deletion unit 1104 configured to delete files each having an importance score value less than or equal to an importance threshold and store files each having an importance score value greater than the importance threshold.

Alternatively, the file processing apparatus further comprises:

a storage space detection module further configured to detect whether the size of the occupied space in the local storage space is greater than or equal to a second storage threshold, and transmit a trigger signal to the file processing module when a detection result indicates that the size of the occupied space is greater than or equal to the second storage threshold, wherein

the file processing module is further configured to delete the stored files in an ascending order of importance score values, until the size of the occupied space is less than or equal to the second storage threshold,

wherein the second storage threshold is less than the first storage threshold.

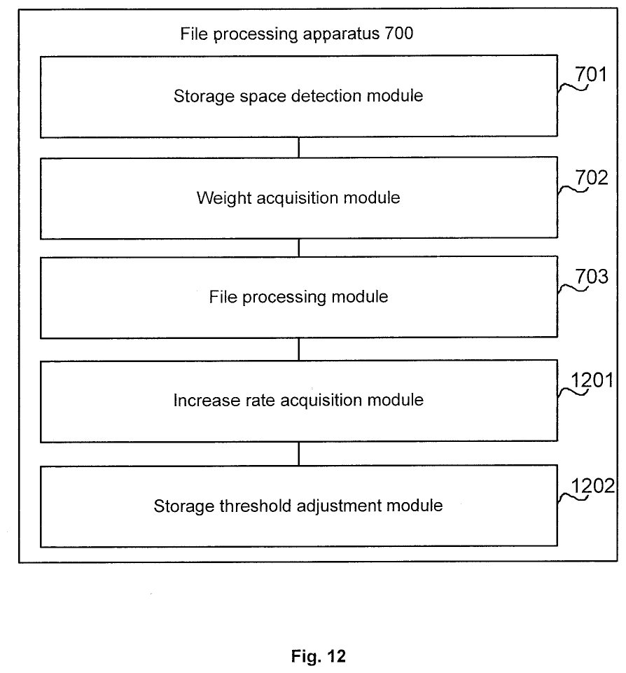

FIG. 12 is a block diagram of a file processing apparatus for a vehicle-mounted monitoring device according to an embodiment of the present disclosure. As shown in FIG. 12, on the basis of the file processing apparatus shown in FIG. 7, the apparatus 700 comprises:

an increase rate acquisition module 1201 configured to acquire an increase rate of the occupied space of the files in the local storage space; and

a storage threshold adjustment module 1202 configured to adjust the second storage threshold according to the increase rate, wherein the increase rate is negatively proportional to the second storage threshold.

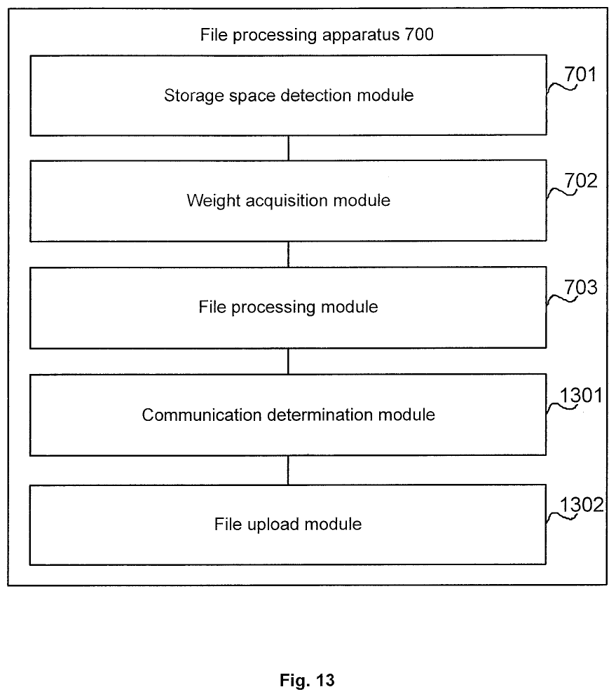

FIG. 13 is a block diagram of a file processing apparatus for a vehicle-mounted monitoring device according to an embodiment of the present disclosure. As shown in FIG. 13, on the basis of the file processing apparatus shown in FIG. 7, the apparatus 700 comprises:

a communication determination module 1301 configured to determine whether the vehicle-mounted monitoring device communicates with a cloud, and transmit a trigger signal when the vehicle-mounted monitoring device communicates with the cloud; and

a file upload module 1302 configured to upload the stored files to the cloud in a descending order of importance score values when receiving the trigger signal from the communication determination module.

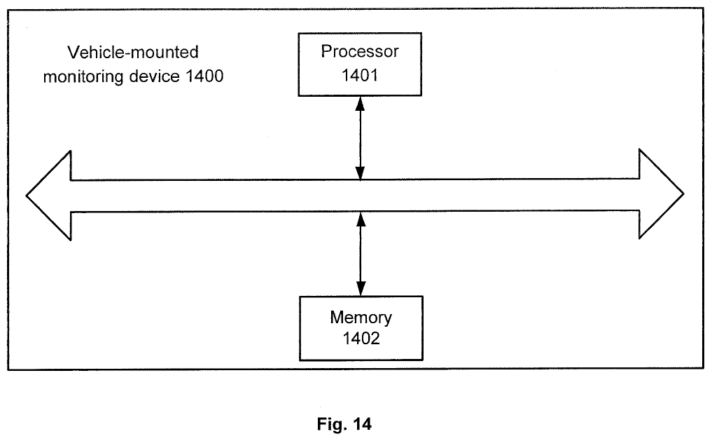

FIG. 14 is a schematic structural diagram of a vehicle-mounted monitoring device according to an embodiment of the present disclosure. As shown in FIG. 14, the vehicle-mounted monitoring device 1400 comprises:

a processor 1401; and

a memory 1402 having stored thereon instructions executable by the processor and files,

wherein the processor 1401 is configured to execute the executable instructions in the memory 1402 to implement the steps of the methods described above.

In the present disclosure, the terms “first” and “second” are used for descriptive purposes only and are not to be construed as indicating or implying relative importance. The term “plurality” refers to two or more, unless specifically defined otherwise.

Other implementations of the present disclosure will be readily apparent to those skilled in the art after considering the specification and practicing the present disclosure. The present disclosure is intended to cover any variations, uses, or adaptations of the present disclosure, which are in accordance with the general principles of the present disclosure and comprise common knowledge or commonly-used technical means in the art which are not disclosed in the present disclosure. The specification and embodiments are to be regarded as illustrative only, and the true scope and spirit of the present disclosure are defined by the appended claims.

It is to be understood that the present disclosure is not limited to the exact structure described above and illustrated in the accompanying drawings, and various modifications and changes may be made without departing from the scope of the present disclosure. The scope of the present disclosure is only limited by the appended claims.

1. A file processing method for a vehicle-mounted monitoring device, comprising:
acquiring locking weights of files in a local storage space if it is detected that a size of an occupied space in the local storage space is greater than or equal to a first storage threshold; and
processing the files according to the locking weights.

2. The file processing method according to claim 1, wherein before acquiring a locking weights of files in a local storage space, the method further comprising:
determining a scene where the vehicle-mounted monitoring device is located; and
determining, based on the scene, the locking weights according to a scene locking policy.

3. The file processing method according to claim 2, wherein
determining a scene where the vehicle-mounted monitoring device is located comprises:
receiving a vehicle environmental parameter collected by each of sensing devices on the vehicle; and
determining, based on a matching relationship between vehicle environmental parameters and scenes, the scene where the vehicle-mounted monitoring device is located according to the collected vehicle environmental parameter.

4. The file processing method according to claim 3, wherein the sensing devices each comprise at least one of an acceleration sensing device, a blind spot monitoring device, a fatigue detection device, a pedestrian detection device, a speed sensor, an image collection device, and an interactive device.

5. The file processing method according to claim 1, further comprising:
acquiring recording times of the files in the local storage space,
wherein processing the files according to the locking weights comprises:
processing the files according to the locking weights and the recording times.

6. The file processing method according to claim 5, wherein processing the files according to the locking weights and the recording times comprises:
determining, based on a matching relationship between locking weights and locking score values, locking score values of the files according to the locking weights;
determining, based on a matching relationship between recording times and time score values, time score values of the files according to the recording times;
determining importance score values of the files according to the locking score values and the time score values; and
deleting files each having an importance score value less than or equal to an importance threshold and storing files each having an importance score value greater than the importance threshold.

7. The file processing method according to claim 6, wherein after storing files each having an importance score value greater than the importance threshold, the method further comprises:
deleting the stored files in an ascending order of importance score values if the size of the occupied space in the local storage space is greater than or equal to a second storage threshold, until the size of the occupied space is less than or equal to the second storage threshold,
wherein the second storage threshold is less than the first storage threshold.

8. The file processing method according to claim 7, wherein after processing the files according to the locking weights and the recording times, the method further comprises:
acquiring an increase rate of the occupied space of the files in the local storage space; and
adjusting the second storage threshold according to the increase rate,
wherein the increase rate is negatively proportional to the second storage threshold.

9. The file processing method according to claim 6, wherein after processing the files according to the locking weights, the method further comprises:
determining whether the vehicle-mounted monitoring device communicates with a cloud; and
uploading the stored files to the cloud in a descending order of importance score values in response to determining that the vehicle-mounted monitoring device communicates with the cloud.

10. A vehicle-mounted monitoring device, comprising:
one or more processors; and
one or more memories connected to the one or more processors and having instructions stored thereon, wherein the instructions which, when executed on the one or more processors, cause the one or more processors to be configured to:
acquire locking weights of files in a local storage space if it is detected that a size of an occupied space in the local storage space is greater than or equal to a first storage threshold; and
process the files according to the locking weights.

11. The vehicle-mounted monitoring device according to claim 10, wherein the one or more processors are further configured to:
determine a scene where the vehicle-mounted monitoring device is located; and
determine, based on the scene, the locking weights according to a scene locking policy.

12. The vehicle-mounted monitoring device according to claim 11, wherein the one or more processors are further configured to:
receive a vehicle environmental parameter collected by each of sensing devices on the vehicle; and
determine, based on a matching relationship between vehicle environmental parameters and scenes, the scene where the vehicle-mounted monitoring device is located according to the collected vehicle environmental parameter.

13. The vehicle-mounted monitoring device according to claim 12, wherein the sensing devices each comprise at least one of an acceleration sensing device, a blind spot monitoring device, a fatigue detection device, a pedestrian detection device, a speed sensor, an image collection device, and an interactive device.

14. The vehicle-mounted monitoring device according to claim 10, wherein the one or more processors are further configured to:
acquire recording times of the files in the local storage space, and
process the files according to the locking weights and the recording times.

15. The vehicle-mounted monitoring device according to claim 14, wherein the one or more processors are further configured to:
determine, based on a matching relationship between locking weights and locking score values, locking score values of the files according to the locking weights;
determine, based on a matching relationship between recording times and time score values, time score values of the files according to the recording times; and
determine importance score values of the files according to the locking score values and the time score values; and
delete files each having an importance score value less than or equal to an importance threshold and store files each having an importance score value greater than the importance threshold.

16. The vehicle-mounted monitoring device according to claim 15, wherein the one or more processors are further configured to:
delete the stored files in an ascending order of importance score values if the size of the occupied space in the local storage space is greater than or equal to a second storage threshold, until the size of the occupied space is less than or equal to the second storage threshold,
wherein the second storage threshold is less than the first storage threshold.

17. The vehicle-mounted monitoring device according to claim 16, wherein the one or more processors are further configured to:
acquire an increase rate of the occupied space of the files in the local storage space; and
adjust the second storage threshold according to the increase rate,
wherein the increase rate is negatively proportional to the second storage threshold.

18. The vehicle-mounted monitoring device according to claim 15, wherein the one or more processors are further configured to:
determine whether the vehicle-mounted monitoring device communicates with a cloud; and
upload the stored files to the cloud in a descending order of importance score values in response to determining that the vehicle-mounted monitoring device communicates with the cloud.
